(19) United States
(12) Patent Application Publication
(10) Pub. No.: US 2008/0226070 A1
(43) Pub. Date: Sep. 18, 2008

(54) COORDINATE-BASED ENCRYPTION SYSTEM, METHOD AND COMPUTER PROGRAM PRODUCT

(76) Inventor: William S. Herz, Hayward, CA (US)

Correspondence Address: Zilka-Kotab, PC, P.O. BOX 721120, SAN JOSE, CA, 95172-1120, US

(21) Appl. No.: 11/685,093

(22) Filed: Mar. 12, 2007

(51) Int. Cl. H04L 9/32

(52) U.S. Cl. 380/258

(57) ABSTRACT

An encryption system, method, and computer program product are provided. After the receipt of encrypted content, a plurality of coordinates associated with a location of a device are identified. In use, the content is decrypted utilizing the coordinates.

### FIELD OF THE INVENTION

The present invention relates to encryption, and more particularly to encrypting content,

### BACKGROUND

In the past, people have received broadcasts, such as radio and television broadcasts, from transmission towers broadcasting signals over the air. Such, traditional broadcasts have generally only required people to utilize antennas in conjunction with output devices (e.g. television, radio, etc.) in order to receive such broadcasts, without requiring payment and/or subscriptions to the associated broadcasting sen-ice.

Lately, more options for receiving broadcasts have become available. For example, people may receive broadcasts via cable transmission, satellite transmission, etc. Typically, such broadcasts are received utilizing set top boxes, such as cable boxes, satellite dish systems, as well as various other devices. Further, such broadcasting options are currently typically provided on a payment basis (e.g. monthly, yearly, etc.) to a particular location associated with a subscription.

Thus, there is unfortunately an incentive for people to circumvent the requirement of paying for a broadcasting service at more than one location. Just by way of example, people may utilize a single set top box in multiple locations (e.g. multiple homes, etc.) in order to eliminate additional costs associated with multiple set top boxes and associated subscriptions to a broadcasting service.

There is thus a need for addressing these and/or other issues associated with the prior art.

### SUMMARY

An encryption system, method, and computer program product are provided. After the receipt of encrypted content, a plurality of coordinates associated with a location of a device are identified, in use, the content is decrypted utilizing the coordinates.

### BRIEF DESCRIPTION OF THE DRAWINGS

FIG. 1 shows a method for decrypting content utilizing device coordinates, in accordance with one embodiment.

FIG. 2 shows a system for decrypting content utilizing device coordinates, in accordance with another embodiment

FIG. 3 shows a method for decrypting content utilizing device coordinates, in accordance with yet another embodiment.

FIG. 4 shows a system for comparing current and authorized coordinates for enabling the decryption of encrypted content, in accordance with another embodiment.

FIG. 5 illustrates an exemplary system with which the various embodiments may be implemented, in accordance with one embodiment.

### DETAILED DESCRIPTION

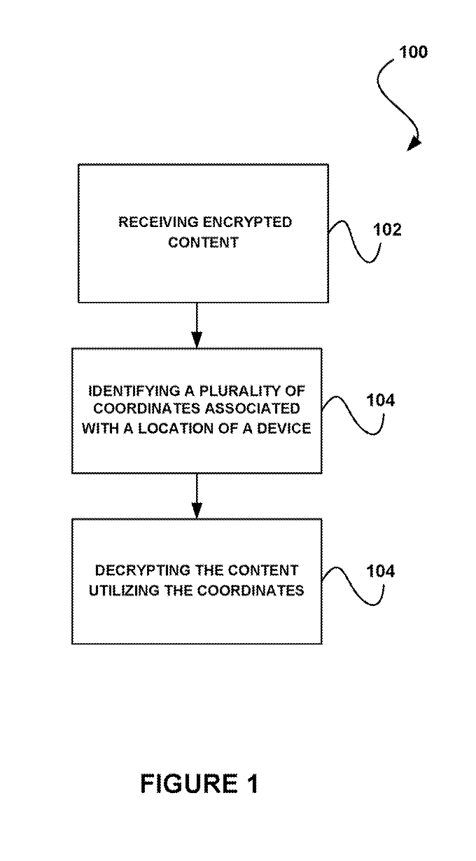

FIG. 1 shows a method 100 for decrypting content utilizing device coordinates, in accordance with one embodiment. As shown in operation 102, encrypted content is received. In the context of the present description, the content may include video content (e.g. television content, etc.), image content, audio content (e.g. radio content, etc.), multimedia content (e.g. Internet content, etc.), textual content, and/or any other content, for that matter. Still yet, the foregoing encryption may include any algorithm, mechanism, etc. whereby the content is incapable of being accessed, at least in part.

In one optional embodiment, the content may be encrypted by a content provider from which the foregoing content is received. Of course, such receipt may be direct or indirect, as desired. Further, it should be noted that other embodiments are contemplated where the content is encrypted by other entities. For example, embodiments are contemplated where a device or associated mechanism receiving the content encrypts the content.

Next, in operation 104, a plurality of coordinates associated with a location of a device is identified. In terms of a definition, the coordinates of the device may include elevation, latitude, longitude and/or any other type of coordinates capable of identifying a location of the device (e.g. in 2D/3D space, etc.). In one possible embodiment, the coordinates may be identified utilizing a global positioning system (GPS). Of course, however, the coordinates may be identified in any desired manner (e.g. by way of triangulation, a cell phone, a terrestrial television, Doppler-based techniques, etc.).

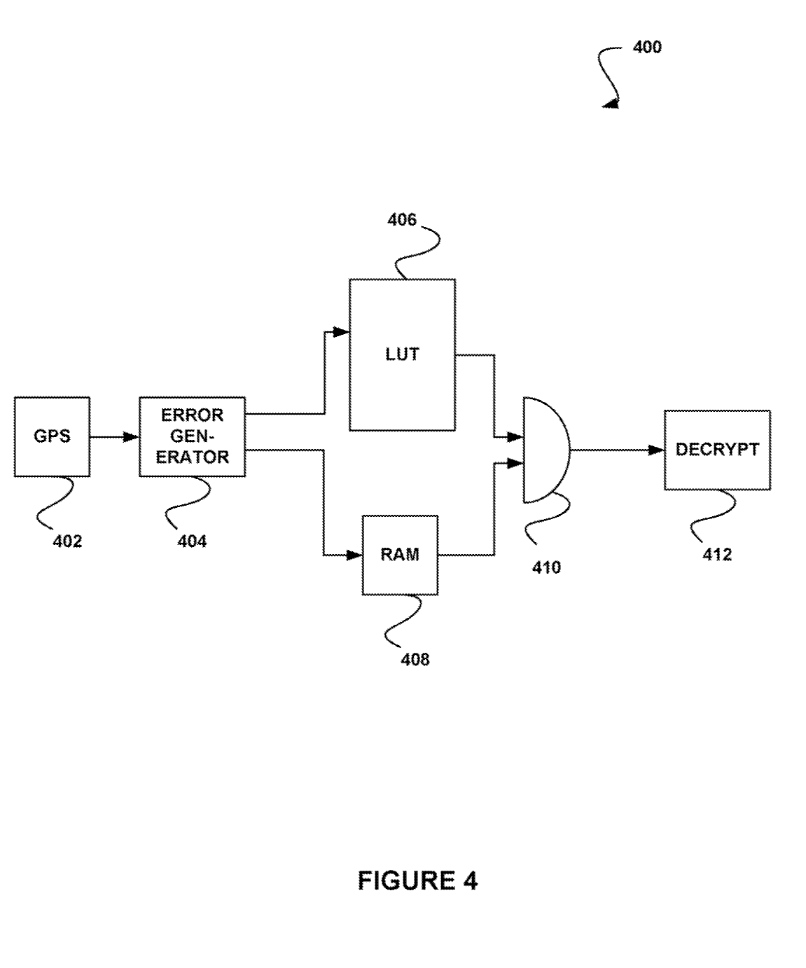

Also in the context of the present description, the device may include anything capable of receiving content. In one embodiment, the device may also optionally include the structure described below with respect to FIG. 4. In various embodiments, the device may include a desktop computer, a lap-top/handheld computer, a personal digital assistant (PDA) device, a mobile phone device, a television, etc. In other embodiments, the device may include a set fop box.

In such embodiment, the set top box may be adapted for receiving content via a satellite content provider. For example, the set top box may include or be connected to a satellite dish, XM radio device, a digital video recorder (DVR), etc. Thus, the set top box may receive television content, radio content, and/or any other content by way of a satellite.

In another optional embodiment, the set top box may be adapted for receiving content via a cable content provider. For example, the set top box may include or be connected to a cable box, a DVR, etc. In this way, the set top box may receive television content, radio content, and/or any other content by way of a cable medium.

With continuing reference to FIG. 1, the content is decrypted utilizing the coordinates. See operation 106. It should be noted that such decryption may be performed in absolutely any manner that uses the coordinates, at least in part. Just by way of example, the content may be encrypted by utilizing the coordinates as a key, such that the coordinates themselves may be used as the key when decrypting the content. In another embodiment, the content may be encrypted by utilizing a predetermined key, and the coordinates may be utilized to gain access to or enable such key. Even still, the key may be included with the content, etc. Of course, any use of the coordinates in association with the decryption is contemplated.

In one optional embodiment, a policy associated with the content may indicate at least one location in which the device may be utilized. For example, at least one set of coordinates may be provided which reflects such location(s) in which the device may be utilized As an option, such coordinates may include a predetermined perimeter (e.g. radius of coordinates, etc.) with respect to a single location. In one embodiment, such predetermined perimeter may be sized to reflect an average or maximum room and/or home size. In other embodiments, the policy may involve various coordinate gradients (e.g. an authorized threshold regarding a rate of change in the coordinates over time, etc.). Furthermore, in different possible embodiments, such location(s) in which the device may be utilized can be determined based on a user registration of the device.

By this feature, location-specific policies may be implemented in various optional embodiments. For example, various programming (e.g. sports, etc.) may be “blacked-out” as a function of the coordinates, etc. In this way, a usage-related policy of the device may be enforced utilizing coordinates of the device in combination with an encryption algorithm.

More illustrative information will now be set forth regarding various optional architectures and uses of different embodiments in which the foregoing method 100 may or may not be implemented, per the desires of the user. It should be strongly noted that the following information is set forth for illustrative purposes and should not be construed as limiting in any manner. Any of the following features may be optionally incorporated with or without the exclusion of other features described.

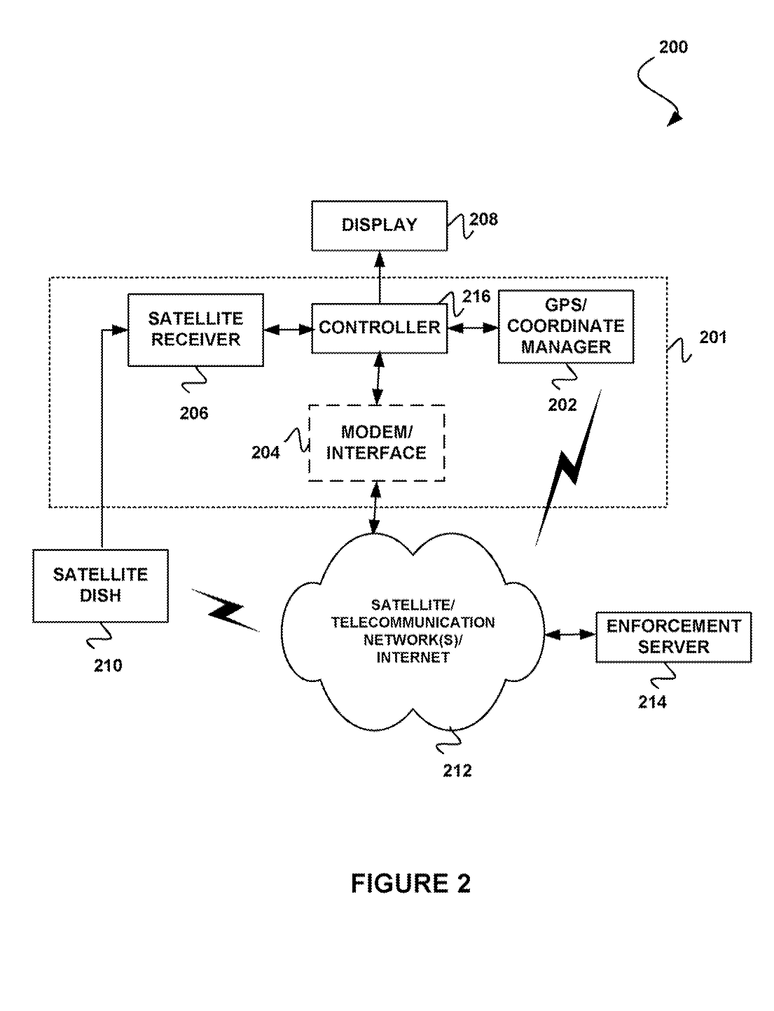

FIG. 2 shows a system 200 for decrypting content utilizing device coordinates, in accordance with another embodiment. As an option, the system 200 may be implemented to carry out the method 100 of FIG. 1. Of course, however, the system 200 may be used in any desired environment. Further, the aforementioned definitions may equally apply to the description below.

As shown in the current embodiment, a device 201 (e.g. set top box, etc.) is included for receiving encrypted content from a satellite dish 210. This may be accomplished utilizing a satellite receiver 206 within the device 201. While the content is received in an encrypted format in the present embodiment, it should be noted that, in other embodiments, the content may be encrypted by the device 201 itself. Further, while a satellite device 201 is set forth and described in the present embodiment, it should be noted that the device 201 may include any device capable of receiving and/or playing back content. For example, the various features set forth herein may be applied in other embodiments that include any of the devices described above with respect to FIG. 1.

As also shown, the device 201 may also be connected with at least one network 212 via a network interface 204 (e.g. modem, Ethernet connection, etc.). The network(s) 212 may include, for example, a satellite network, a telecommunications network, a local area network (LAN), a wireless network, a wide area, network (WAN) such as the Internet, a peer-to-peer network, a WiMAX network, a cable network, etc. Thus, the device 201 may be capable of sending and receiving information over the network(s) 212, While a network connection is present in the current embodiment for reasons that will soon become apparent, it should be noted that other embodiments are contemplated where such network connection is omitted.

During normal use, a controller 216 may control the device 201 to decrypt and output the content via the satellite receiver 206 and satellite dish 210, utilizing a display 208. The controller 216 may also receive current coordinates associated with the device 201 from a GPS/coordinate manager 202 located within or externally coupled to the device 201. The current coordinates may include a precise location of the device 201, at a given instant.

In various embodiments, the GPS/coordinate manager 202 may periodically identify the current coordinates of the device 201. For example, the GPS/coordinate manager 202 may, under the direction of the controller 216, identify the current coordinates of the device 201 according to predetermined time periods (e.g. one second, etc.). As another option, the GPS/coordinate manager 202 may identify the current coordinates of the device 201 each time the device 201 is powered on.

Furthermore, in one embodiment, the GPS/coordinate manager 202 may further store a set of authorized coordinates. In particular, the GPS/coordinate manager 202 may optionally receive and store authorized coordinates during a registration (e.g. initialization, etc.) of the device 201. One example of such registration will be described hereinafter in greater detail.

Of course, in other embodiments, the authorized coordinates may be stored at an enforcement server 214 by way of the network 212. Such enforcement server 214 may optionally be associated with a service provider that authorizes and provides service to such device 201. In any case, the authorized coordinates serve to indicate where the device 201 is authorized to be located and functioning. For example, the authorized coordinates may be matched with those in the device 201.

In still other embodiments, the device 201 may be equipped with the authorized coordinates at an authorized location. For example, such authorized location may include a store where the device 201 and/or associated service is purchased. Further, the coordinates may be inferred from an address of a purchaser. Thus, the device 201 need not necessarily communicate with the enforcement server 214, in such embodiment.

Before use, a registration procedure may be carried out to register (e.g. initialize, etc.) the device 201. Specifically, the device 201 may be registered automatically when the device 201 is first connected to the satellite dish 210, and/or the enforcement server 214 via the network interface 204. The device 201 may also be registered upon a user calling a service provider to setup the device 201, and/or upon a user manually initiating the registration procedure via a graphical user interface (GUI) of the device 201 which relays information over the network 212 via the network interface 204. Of course, this and/or other protocols disclosed herein may vary depending on whether bi- or unidirectional communication is employed.

Specifically, the registration may involve the identification of the authorized coordinates associated with a location of the device 201. The authorized coordinates may be identified utilizing the GPS/coordinate manager 202, and may further include the current coordinates at the time of registration. Of course, however, the authorized coordinates may be identified in any desired manner. For example, an authorized address entered by the user (e.g. via the aforementioned GUI, etc.) may be translated into the authorized coordinates. Further, as mentioned before, the authorized coordinates may be stored in the GPS/coordinate manager 202 and/or enforcement server 214.

As an option, the registration procedure may also include verifying the coordinates. For example, input may be received from a user for verifying that such coordinates identify the location in which the device 201 is to be used. As another option, if the coordinates are not verified, the device 201 may not be registered and may therefore remain non-functional.

In various embodiments, multiple sets of additional authorized coordinates may optionally be identified during the registration procedure. Such additional authorized coordinates may be identified based on the original authorized coordinates. Just by way of example, the additional authorized coordinates may be identified based on a policy associated with the device 201.

In one example, the additional authorized coordinates may include coordinates within a predetermined perimeter surrounding the original authorized coordinates. In another example, the additional authorized coordinates may include manually entered coordinates. Still yet, the additional authorized coordinates may be representative of multiple mutually exclusive locations where use of the device 201 is authorized. Of course, however, the additional authorized coordinates may be identified in any desired manner.

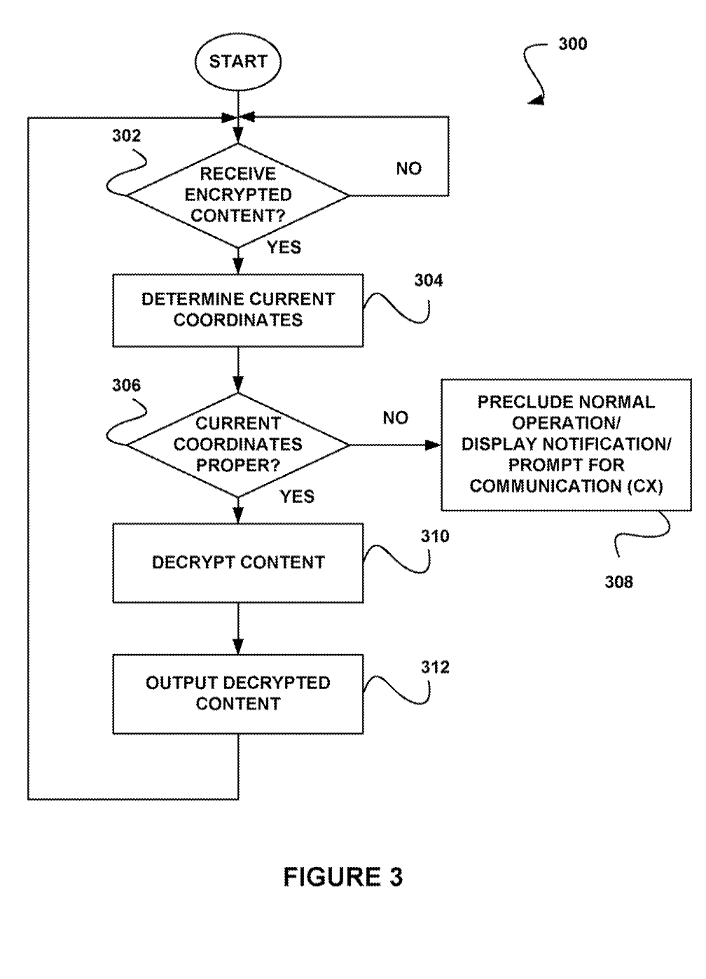

By this design, the controller 216 may therefore utilize the current coordinates received from the GPS/coordinate manager 202 to decrypt the received encrypted content. If the current coordinates resides outside the authorized coordinates, the controller 216 will not be able to decrypt the content, thereby enforcing any location-based policy associated with the device 201. More information regarding such encryption and location-based policy enforcement will be set forth hereinafter in greater detail during reference to FIG. 3

In other embodiments, multiple devices may exist, namely a master device and one or more slave devices. In such embodiment, the coordinates of the devices may be compared. To this end, a relative distance, position, etc, of the master/slave devices may be used for decrypting the content. Of course, similar functionality may be afforded without the devices necessarily taking on a master-slave relationship.

In this way, the system 200 only permits the device 201 to access the encrypted content within an authorized area. Thus, any incentive for theft of the device 201 may be eliminated. In addition, circumvention of service policies by utilizing the device 201 in multiple areas may be prevented.

Further, in other embodiments, domestic enforcement may be afforded (to prevent use outside a predetermined state, country, etc.). In still yet additional embodiments where multiple devices coexist, an associated policy may provide a diversity of programming on such units. For example, one device may be capable of presenting adult content while another one may not, etc.

FIG. 3 shows a method 300 for decrypting content utilizing device coordinates, in accordance with yet another embodiment. As an option, the method 300 may be implemented in the context of the details of FIGS. 1 and/or 2. Of course, however, the method 300 may be carried out in any desired environment. Further, the aforementioned definitions may equally apply to the description below.

Once the device is registered with the authorized coordinates defined, the device may be utilized by a user for receiving encrypted content. See decision 302. Upon receipt of such encrypted content, current coordinates of the device are determined, as shown in operation 304. As an option, the current coordinates may be determined upon each power up of a device. As another option, the current coordinates may be determined periodically based on predetermined time periods.

Nest, it is determined whether the current coordinates are proper (e.g. do they correlate with the authorized coordinate, etc.). See decision 306. The authorized coordinates may, in various embodiments, be identified in local memory within the device, or via a remote server.

In one embodiment, the current coordinates and the authorized coordinates may be compared by the device. In another embodiment, the current coordinates and the authorized coordinates may be compared by a server separate from the device. In addition, the current coordinates may be transmitted to the server (where the authorized coordinates reside) for performing the comparison. Of course, it should be noted that the current coordinates and the authorized coordinates may be compared by any desired device capable of performing such comparison.

If the current coordinates are determined to be the same as at least one of the authorized coordinates (or within a predetermined level of error, etc.), the encrypted content is decrypted and outputted. Note operations 310-312. Thus, usage of the device may be conditionally permitted based on the comparison. One example of a system for carrying out the foregoing functionality of operations 304-312 will be set forth in greater detail during reference to FIG. 4.

If however, the current coordinates are not determined to be the same as any of the authorized coordinates, decryption may be precluded and normal functionality of the device may be temporarily terminated. Further, a notification may be displayed along with a prompt for a communication. See operation 308. Specifically, the notification may be displayed to a user of the device. Further, the notification may inform the user that the device is outside of its authorized operating area. Still yet, the notification may inform the user of the authorized operating area based on the authorized coordinates, or report next time a connection occurs.

Additionally, the prompted communication may include any communication to be sent from the device to a remote server. For example, the communication may include a call, a data transmission (e.g. e-mail, website interaction, etc.) via any integrated or separate interface, etc. Further, the communication may, in one embodiment, be predicated on entry of appropriate log-in information (e.g. user name, password, etc.).

In another embodiment, at least one authorized source of the communication may be identified. The authorized source may include any predetermined source (e.g. port, internet protocol address, phone number, e-mail address, etc.) from which the user of the device is authorized to communicate. In such embodiment, the authorized source may be one of a plurality of authorized sources stored within the device and/or a separate server. In addition, the authorized source may be defined by the user and/or the service provider at the time of registration of the device, for example.

As an option, it may be determined whether the communication was successful by verifying the log-in information, comparing the authorized source of the communication with an actual source of the communication, etc. Specifically, in the latter embodiment, the aforementioned ports, internet protocol addresses, phone numbers, etc. may be compared. Of course, however, the success of the communication may be determined in any desired manner.

If it is determined that the communication was not successful (e.g. that the comparison was not successful), normal operation of the device may be continuously precluded. Moreover, decryption of content may only be resumed once it is determined that the device is located within the authorized area, without having to permanently disable pending verbal authorization involving an operator.

If, however, it is determined that the communication was successful, a GUI may be displayed to the user utilizing the device in order to update authorized coordinates and/or sources associated with the device. Just by way of example, the GUI may enable the user to re-register the device with a new set of authorized coordinates and/or sources. In this way, a user may be permitted to change authorized coordinates and/or sources associated with a device.

Optionally, the authorized coordinates and/or sources may only be allowed to be updated a predetermined number of times. For example, the authorized coordinates and/or sources may be allowed to be updated once a year, once every three years, two times total, etc. In one embodiment, the service provider may define the number of times the authorized coordinates and/or sources may be updated. To this end, decryption of the encrypted content may be permitted upon such update.

FIG. 4 shows a system 400 for comparing current and authorized coordinates for enabling the decryption of encrypted content, in accordance with another embodiment. As an option, the system 400 may be implemented in the context of FIGS. 1-3. For example, the system 400 may be used for carrying out the foregoing functionality of operations 304-312 of FIG. 3. Of course, however, the system 400 may be carried out in any desired environment. Further, the aforementioned definitions may equally apply to the description below.

As shown, included is a GPS 402 coupled to an error generator 404 which, in turn, feeds a read-only look up table (LUT) 406 and random access memory (RAM) 408. Coupled to the LUT 406 and RAM 408 is a comparator 410 that feeds a decryption module 412. It should be noted that any of the components (with the exception of the GPS 402) may be positioned either in a device adapted to receive content (e.g. device 201 of FIG. 2, etc.) and/or a remote server (e.g. remote server 214 of FIG. 2, etc.).

Prior to use (e.g. during registration), the LUT 406 may be burned with a set of authorized coordinates. This may be accomplished, for example, by positioning the system 400 including the GPS 402 at a location where operation is desired. In response to a local or remote command, an initial set of coordinates may be fed to the error generator 404 which, in turn, generates a range of authorized coordinates based on a predetermined error amount. For example, if the set of coordinates includes latitude_X, longitude_Y, the error generator 404 may output latitude_X′, longitude_Y′, latitude_X″, longitude_Y″, latitude_X′″, longitude_Y′″, etc., which, in turn, are burned in the LUT 406.

In use, the GPS 402 may be used to generate a set of current coordinates. Similar to the registration process, the error generator 404 generates a range of current coordinates based on the current coordinates. Unlike the registration process, however, such range of current coordinates are fed to a RAM 408 such that the range of current coordinates in the RAM 408 may be compared with the range of authorized coordinates in the LUT 406 utilizing the comparator 410.

Based on the foregoing comparison by the comparator 410, a key associated with the decryption module 412 may be enabled. To this end, the key may be used to decrypt encrypted content. It should be strongly noted that the foregoing architecture is set forth by way of example only and should not be construed as limiting in any manner, as any technique for utilizing the current coordinates to decrypt the content may be utilized.

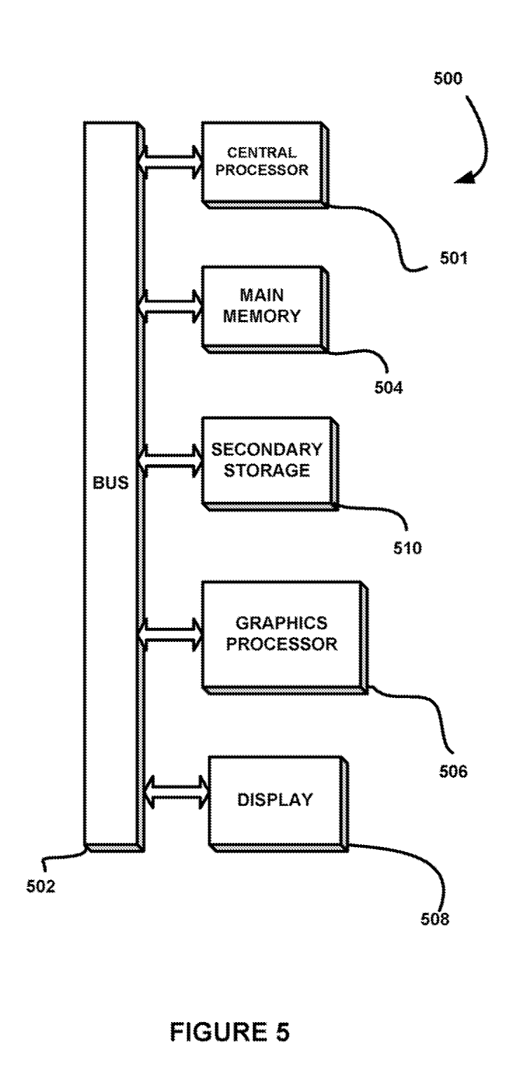

FIG. 5 illustrates an exemplary system 500, in accordance with one embodiment. As an option, the enforcement server 214 of FIG. 2 may take the form of the system 500. In other embodiments, the device 201 of FIG. 2 may be modeled after the system 500 but, of course, may be also equipped with the additional components shown in FIG. 2 (e.g. receiver, GPS/coordinate manager, etc.).

As shown, a system 500 is provided including at least one central processor 501 which is connected to a communication bus 502. The system 500 also includes main memory 504 [e.g. random access memory (RAM), etc,]. The system 500 also includes a graphics processor 506 and a display 508.

The system 500 may also include a secondary storage 510. The secondary storage 510 includes, for example, a hard disk drive and/or a removable storage drive. representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving encrypted content;
identifying a plurality of coordinates associated with a location of a device; and
decrypting the content utilizing the coordinates.

2. The method of claim 1, wherein the coordinates are identified utilizing at least one of a global positioning system and tri angulation.

3. The method of claim 1, wherein the device includes a set-top box.

4. The method of claim 3, wherein the set top box is adapted for receiving content via a satellite content, provider.

5. The method of claim 3, wherein the set top box is adapted for receiving content via a content provider.

6. The method of claim 1, wherein the coordinates are encrypted.

7. The method of claim 1, wherein an acceptable range of current coordinates is generated based on the coordinates.

8. The method of claim 7, wherein the acceptable range of current coordinates is based on a predetermined amount of error.

9. The method of claim 7, wherein the acceptable range of current coordinates is compared with predetermined coordinates.

10. The method of claim 9, wherein the predetermined coordinates are determined during registration of the device.

11. The method of claim 9, wherein the predetermined coordinates are stored in a look-up table.

12. The method of claim 9, wherein the predetermined coordinates are stored in read-only memory.

13. The method of claim 9, wherein a key is enabled based on the comparison.

14. The method of claim 13, wherein the encrypted content is decrypted utilizing the key.

15. The method of claim 1, wherein the content is encrypted utilizing a key.

16. The method of claim 1, wherein a key is included with the encrypted content, and the content is decrypted utilizing the coordinates and the key.

17. A method, comprising:
identifying and communicating a plurality of coordinates associated with a location of a device; and
encrypting content utilizing the coordinates.

18. A system, comprising:
a processor for identifying a plurality of coordinates associated with a location of a device, and decrypting content utilizing the coordinates.

19. The system of claim 18, wherein the processor is coupled to memory via a bus.

20. The system of claim 18, wherein the processor is a component of a set top box.
